(19) United States
(12) Patent Application Publication
(10) Pub. No.: US 2026/0291987 A1
(43) Pub. Date: Sep. 24, 2026

(54) Improving Traffic Inspection and Response with Smart Agents and Unified Inspection Data Points

(71) Applicant: Zscaler, Inc., San Jose, CA (US)

(72) Inventors: Sandeep Paul, Bangalore (IN); Nirmal Singh, Mohali (IN); Deepen Desai, San Jose, CA (US)

(73) Assignee: Zscaler, Inc., San Jose, CA (US)

(21) Appl. No.: 19/199,675

(22) Filed: May 6, 2025

(30) Foreign Application Priority Data
Mar. 24, 2025 (IN) 202541026894

(51) Int. Cl. H04L 9/40

(52) U.S. Cl. CPC H04L 63/1466; H04L 63/20

(57) ABSTRACT

Systems and methods for improving traffic inspection and response with smart agents and unified inspection data points include monitoring network traffic associated with a plurality of computing devices each having an agent application executing thereon, the monitoring including collecting inspection data based on the network traffic; receiving process-level data from each agent application; unifying the process-level data with the collected inspection data; and analyzing the unified data to detect anomalous or malicious activity.

### FIELD OF THE DISCLOSURE

The present disclosure generally relates to network and cloud security. More particularly, the present disclosure relates to systems and methods for improving traffic inspection and response with smart agents and unified inspection data points.

### BACKGROUND OF THE DISCLOSURE

Modern organizations rely heavily on network-based security solutions—such as firewalls, proxy servers, intrusion detection systems, and cloud-based scanning services—to detect and mitigate cyber threats. Traditional approaches typically focus on inspecting network traffic by analyzing packet-level data, applying threat signatures, or enforcing policy rules. However, as the volume of encrypted traffic grows and attackers employ more sophisticated techniques like traffic mimicking and obfuscation, network-centric solutions alone often fail to detect subtle indicators of malicious activity. To overcome these challenges, security vendors have made attempts to integrate endpoint data with network intelligence. However, many such efforts remain fragmented. Accordingly, there is a need for an improved system and method that integrates detailed, host-level process data with real-time network inspection.

### BRIEF SUMMARY OF THE DISCLOSURE

The present disclosure relates to systems and methods for improving traffic inspection and response with smart agents and unified inspection data points. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include monitoring network traffic associated with a plurality of computing devices each having an agent application executing thereon, the monitoring including collecting inspection data based on the network traffic; receiving process-level data from each agent application; unifying the process-level data with the collected inspection data; and analyzing the unified data to detect anomalous or malicious activity.

The steps can further include generating a response action based on the analyzing, wherein the response action includes at least one of blocking suspicious traffic or issuing an alert. The process-level data can include any of a process responsible for the traffic, a file path of a process responsible for the traffic, parent-child process relationships, Central Processing Unit (CPU) usage of a process, an associated company name of a process, and a recent file creation timestamp. The analyzing can include employing one or more cloud-based security services, wherein the one or more cloud-based security services include any of a deep packet inspection engine, a cloud browser isolation service, a policy enforcement engine, and a behavioral analysis module. The steps can further include determine whether a process associated with the network traffic is recognized; responsive to the process being unrecognized, invoking a selected security service for detailed traffic analysis; and applying one or more security policies based on an output of the detailed traffic analysis. The steps can further include determining, based on unified data, a process responsible for traffic executing from a nonstandard directory on a computing device; and performing one or more actions based on the determining, the one or more actions including any of blocking the traffic and alerting an administrator. The steps can further include determining that traffic is directed to an unknown destination; determining that a process responsible for the traffic is any of a core system process, a trusted process, or a known third party process; determining that a file associated with the traffic has a creation timestamp within a predefined threshold; and performing one or more actions based on the determining, the one or more actions including any of blocking the traffic and alerting an administrator. The analyzing can include detecting code injection or anomalous behavior based on a parent-child process relationship or recent file creation, and generating a security alert upon detecting the code injection or anomalous behavior. The steps can include utilizing the process-level data to perform application categorization.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a traditional network traffic inspection architecture.

FIG. 6 is a flow diagram of an improved network traffic inspection architecture utilizing smart agents and unified inspection data.

FIG. 7 is a flowchart of an example operation of the present system for utilizing unified inspection data.

FIG. 8 is a flowchart of a process for improving traffic inspection and response with smart agents and unified inspection data points.

### DETAILED DESCRIPTION OF THE DISCLOSURE

Again, the present disclosure relates to systems and methods for improving traffic inspection and response with smart agents and unified inspection data points. Various embodiments enhance network security by integrating detailed, host-level process data into traditional network traffic inspection. An agent application running on each endpoint collects context, such as process names, file paths, timestamps, and parent-child relationships, then forwards that information alongside the network traffic to cloud-based security services. By unifying this enriched host data with existing network analysis, the invention enables more accurate threat detection, faster incident response, and proactive policy enforcement, ultimately creating a more robust and efficient security framework.

### § 1.0 Cybersecurity Monitoring and Protection Examples

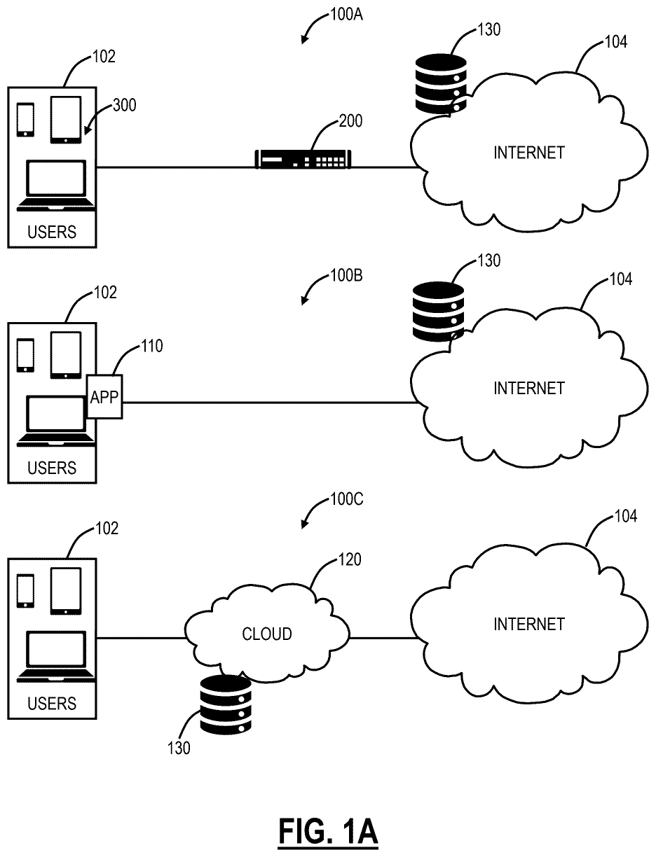

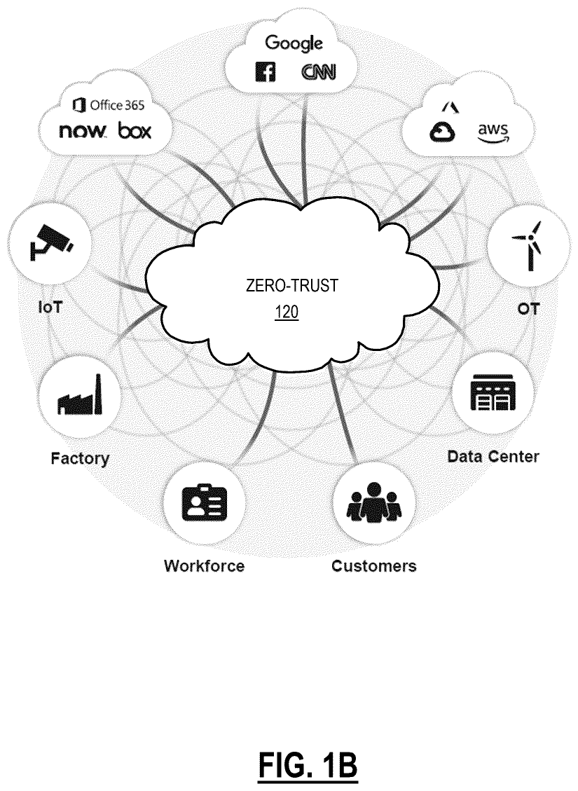

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

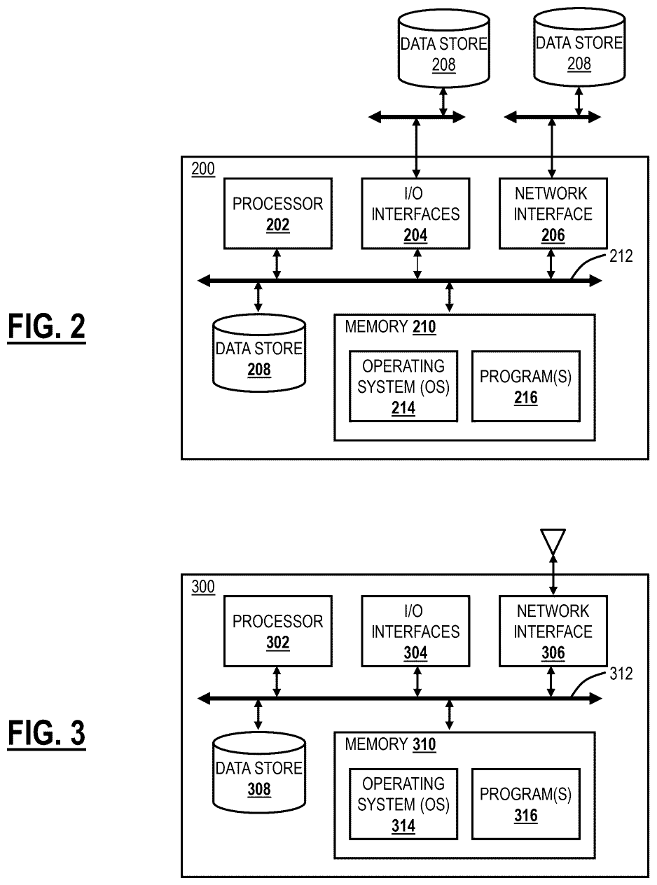

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing D Evice Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 (agent application) that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

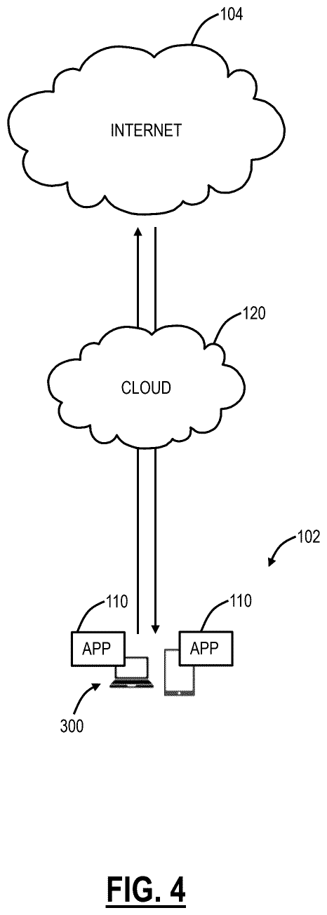

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Smart Agents for Unified Monitoring Data

The present disclosure encompasses systems and methods aimed at enhancing network detection effectiveness, response, and performance through the use of smart agents that unify inspection data points. Various embodiments of this disclosure include strategies for improving the detection efficacy and performance of network-based security technologies by utilizing meshed or unified data.

Unified or meshed data refers to the integration of data related to processes, files, and computing resources, which is collected and associated with network traffic. This data is then subjected to inspection by network-based security technologies such as the various security services of the cloud 120 described herein. The responsibility for collecting and associating this data falls on a lightweight agent installed on the end-user's system. These lightweight agents have an expanded role that includes not only data collection but also the curation of this data.

By unifying data points related to processes, files, and network traffic, the visibility of network-based security technologies is significantly enhanced. This increased visibility strengthens their detection capabilities, enabling more effective identification of threats. Additionally, the unification of data points can lead to a reduction in the costs associated with network traffic inspection.

Beyond improving real-time detection abilities, the associated data can also be utilized in a passive or offline manner for a variety of purposes. These include threat hunting, breach detection, incident response, forensics, and more. This comprehensive approach to data unification and association thus offers a robust framework for enhancing both the efficacy and efficiency of network security technologies.

The proposed solution addresses several critical challenges in network security. Firstly, by utilizing selective data, the scope of capturing and trapping malicious traffic is significantly broadened, thereby overcoming the limitations of network-based inspection technologies that rely on conservative and minimalistic pattern matching languages. This approach enhances the ability to identify and mitigate threats effectively.

Secondly, this solution conserves resources devoted to data integration, correlation intelligence, and computing power required to piece together various data points for activities such as threat hunting, breach detection, forensics, and incident response. Since all relevant data points are collected and integrated simultaneously by the same agent, the process becomes more efficient and less resource-intensive.

Furthermore, curated data helps protect security technologies from being overwhelmed by excessive data volumes. By filtering and organizing data before it reaches security systems, these technologies can operate more efficiently and focus on the most pertinent information.

The inclusion of comprehensive data strengthens detection precision and supports the development of proactive security strategies. This means that security measures can be more accurately targeted and implemented before threats fully materialize. Additionally, the solution allows for the pruning and substitution of bulky and increasingly large blocklisting databases and signature repositories. By refining and reducing the number of signatures needed, the system can maintain effectiveness while reducing the computational load.

Lastly, with enhanced data visibility, precise threat detection can be achieved more quickly, improving overall performance and reducing overhead. This means that potential threats can be identified and addressed at the earliest possible stage, ensuring a more secure and efficient network environment.

Security vendors and technologies have long been engaged in a relentless battle against threat actors, constantly striving to stay ahead of the increasingly sophisticated and complex nature of cyber-attacks. Network-based security technologies, in particular, often struggle to keep pace with the evolving tactics of threat actors and the inherent limitations of their inspection engines. Compounding these challenges is the ever-growing volume of network traffic, which makes it even more difficult to identify and mitigate threats effectively.

Despite these daunting challenges, security vendors have made concerted efforts to enhance conventional technologies with newer, more advanced solutions. However, these newer technologies come with their own set of challenges, including high costs, the necessity for frequent updates, performance overheads that limit their selective utilization, and various support limitations. These factors collectively hinder the overall efficacy and widespread adoption of such technologies.

Conventional security solution vendors have shown significant expertise in their respective fields, continuously innovating to thwart attacks and minimize damage. However, these solutions often operate in isolation, lacking crucial contextual data that would enhance their effectiveness. A significant drawback common among many security solution providers is the absence of comprehensive security aspects within their technologies.

Network-based security vendors have employed end-point agents, but these agents tend to be lightweight and limited in scope. Their primary functions include creating secure tunnels, directing traffic to proxy servers, and enforcing policies. The design and development of host and network-based security technologies have largely been disconnected and managed by separate technology providers. This separation of data from its origin, consumer, and context has deprived these technologies of the necessary perspective, thereby impairing their efficacy, performance, and overall utilization.

Several security vendors have attempted to bridge this gap by developing technologies such as correlation engines, which stitch together data from various sources. However, these technologies only address specific security needs and often lack real-time threat detection capabilities.

One of the primary pitfalls in network-based security technologies is the lack of contextual data. Inspection engines often operate with limited visibility into the context surrounding the data, such as the originator, consumer, and the inherent merit of the data. This lack of context is a significant limitation, as network-based security technologies typically focus on inspecting network traffic to identify malicious activity, with minimal insights from the host system, such as the processes responsible for generating the network traffic. This gap in information can hinder the accurate identification and mitigation of threats.

Another major challenge is the increased complexity introduced by the widespread adoption of Secure Sockets Layer (SSL). SSL encryption, while essential for securing communications, adds layers of complexity that degrade the efficacy and performance of network-based security technologies. The encryption makes it more challenging for inspection engines to analyze the data effectively, leading to potential blind spots in security coverage.

Threat actors further complicate the landscape by employing sophisticated techniques such as encryption, encoding, obfuscation, and mimicking legitimate traffic. These techniques are designed to evade detection, rendering traditional network-security technologies less effective. The ability of threat actors to obscure their activities means that security technologies need to continuously evolve to keep pace with these advanced tactics.

The deployment of multiple security technologies over the same data set can also introduce significant overhead without providing proportional benefits. This practice can lead to increased delays and higher demands on computing resources, as each technology may require substantial processing power and time to analyze the data. The redundancy and inefficiency of this approach can diminish the overall performance of the security infrastructure.

Additionally, the sheer volume of data that needs to be inspected can be overwhelming for security technologies. Without proper data curation, these technologies can become inundated with information, making it difficult to identify genuine threats amidst the noise. The lack of targeted data curation reduces the effectiveness of security measures and can lead to missed detections and slower response times.

To address these challenges, several strategic steps can be implemented. One crucial solution is empowering endpoint agents to collect specific data related to processes, files, and computing resources. By gathering detailed information from the host system, these enhanced endpoint agents provide valuable context that can significantly improve threat detection accuracy.

Another effective approach is unifying network traffic with relevant data as it is observed. By associating network traffic with contextually rich data from the host system, security technologies can perform more comprehensive and accurate inspections. This unification provides sufficient context for both real-time inspection and offline investigation, enabling a more thorough analysis of potential threats.

Selective data collection and curation are also essential in reducing the volume of data that inspection engines must handle. By focusing on the most relevant and necessary data, this approach minimizes the burden on inspection engines and ensures that the data being analyzed is of high quality. This targeted data transmission over the network helps in addressing the expertise required for data correlation and reduces unnecessary network traffic, enhancing the overall efficiency and effectiveness of the security infrastructure.

In summary, by addressing the common pitfalls through the empowerment of endpoint agents (agent applications), unification of network traffic with relevant data, and selective data collection and curation, the efficacy and performance of network-based security technologies can be significantly improved. These strategic steps help in overcoming the limitations of traditional approaches and provide a robust framework for enhanced network security.

The invention described herein offers numerous valuable improvements in network security through data unification, significantly enhancing detection and response capabilities. One of the primary advantages is precise threat detection. By unifying data points, threats can be detected at the earliest stages, minimizing potential damage. This approach also reduces the operational overhead of inspection engines, which typically involves maintaining session information, SSL encryption/decryption, and costly deep packet inspection. With unified data, the system can operate more efficiently and effectively.

Another significant benefit is simplified malware detection. Malware-generated traffic can be identified more easily without the need for complex decryption, decoding, or detection logic that spans multiple packets. This simplification allows for faster and more accurate identification of malicious activity, enhancing overall security measures.

The invention also provides broader visibility. Enhanced visibility gives inspection technologies a larger target surface area to capture threats, even when working with constrained languages. This increased visibility improves the ability to detect a wider range of threats, making the security system more robust.

Reduced maintenance and updates are another key value of the invention. The need for frequent updates and purging of URL/domain/IP blacklists and threat detection patterns can be minimized. This reduction allows for the creation of better generic and heuristic signatures, streamlining the maintenance process and improving the overall efficiency of the security system.

The invention also supports proactive threat handling. Researchers are better equipped to handle threats proactively, thanks to the comprehensive and context-rich data provided by the unified approach. This proactive capability enhances the ability to anticipate and mitigate potential threats before they can cause significant harm.

The versatile unified data generated by the system can be leveraged by various security services. These include threat hunting, breach detection, red teaming/VAPT, forensics, incident response/SOC, and AI/ML-based detection technologies. For example, data like module version can be highly informative to red teaming/VAPT teams, providing valuable insights that improve the effectiveness of their operations.

Additionally, the unified data can be utilized across different technologies, such as URL categorization/classification, cloud browser isolation, sandboxing, and Data Loss Prevention (DLP). This cross-technology utilization ensures that the data collected and curated by the system can benefit a wide range of security processes, enhancing overall network security management.

By addressing common pitfalls and leveraging specific elements that unify and contextualize data, this invention significantly enhances the efficacy and performance of network-based security technologies. This holistic and integrated approach provides a robust framework for improving threat detection, response, and overall network security management, ensuring a more secure and efficient operation of network security systems.

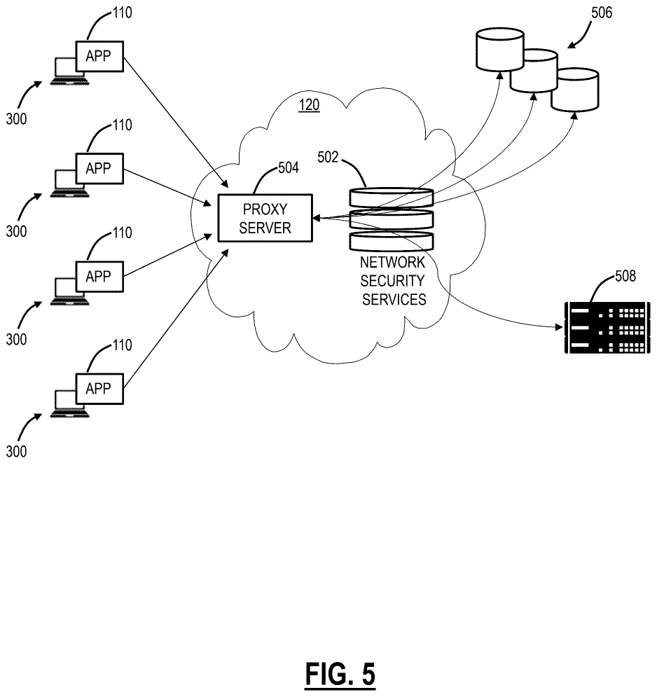

FIG. 5 is a flow diagram of a traditional network traffic inspection architecture. In a traditional approach to network traffic inspection, one or more cloud-based security solutions, i.e., network security services 502, examine the data flowing between multiple computing devices 300 and the internet. Each computing device 300 runs an agent application 110 that is configured to forward its network traffic to the cloud 120. More specifically, this traffic is first routed through a proxy server 504, which then distributes it to various security services 502 for inspection. In addition to forwarding the traffic for security analysis, the proxy server 504 also communicates with essential DNS infrastructure 506, such as root name servers, TLD servers, and authoritative name servers, to facilitate domain name resolution on behalf of client computing devices 300.

A typical operation unfolds in several steps. First, the agent application 110 on a computing device 300 sends a DNS query to the proxy server 504, which then forwards that query to a root name server as part of the standard name resolution process. Once the required domain is resolved, the agent application receives the corresponding IP address of the destination. Next, the agent application 110 sends a request packet to the proxy server 504, and this traffic passes through the security services 502 for inspection. In order to analyze and filter the traffic effectively, using measures such as decryption, domain blocking, or Deep Packet Inspection (DPI), the security services 502 process the data before relaying it to the destination server 508 on behalf of the client computing device 300. Despite these safeguards, this traditional solution can overlook critical indicators of malicious activity, allowing harmful traffic to traverse the network undetected.

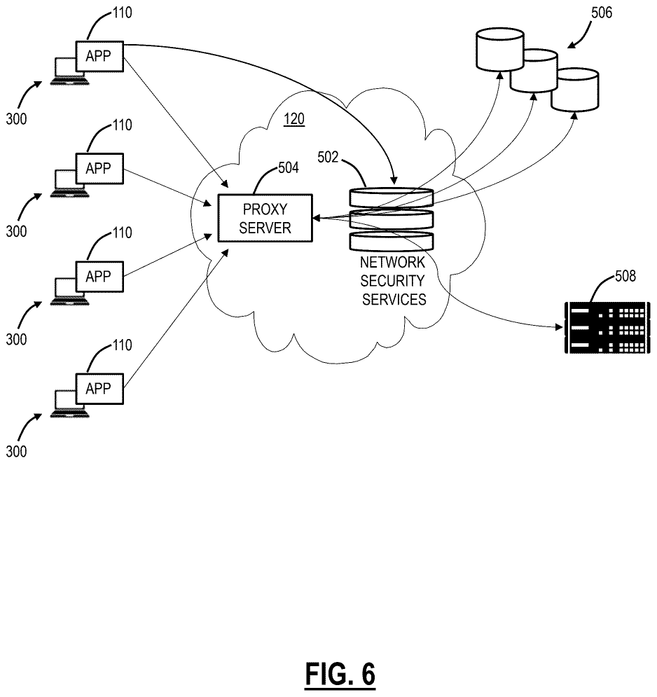

FIG. 6 is a flow diagram of an improved network traffic inspection architecture utilizing smart agents and unified inspection data. By incorporating the smart agents of the present invention, the smart agents can provide information such as a process on the device, the path of the process on the device initiating the traffic, etc. It will be appreciated that the “smart agents” of the present application can be contemplated as the agent applications 110 with additional features. Based thereon the “smart agents” will be referred to as agent applications 110 hereinafter.

These agent applications 110 are designed to collect additional, critical information from the computing device 300 and directly provide it to the various security services 502 offered by the cloud 120. These security services are then capable of unifying this supplementary information with the existing monitored data. The additional information can encompass a wide range of details, such as the specific process on the device initiating the traffic, the file path of the process, the associated company name, the process creation time, the file creation time, parent-child process relationships, and the CPU usage of the process. Such detailed information is not accessible to traditional security services.

With this enriched dataset, specific policies can be crafted and enforced by the present systems to enhance customer protection against cyber-attacks. For instance, one example detection facilitated by the present systems can identify any processes executing from non-standard directories or paths on a client device, signaling potential threats. In another example, if a security service 502 detects that traffic is directed to an unknown destination and that the process name corresponds to a core system process, trusted process, or a known third-party process, and further finds that a file associated with this traffic has a creation timestamp within the past 10 minutes, the system can be configured to block such traffic. This is based on the premise that a trusted process is highly unlikely to request a connection to an unknown destination with a file that was recently created.

Such detailed detection capabilities are profoundly useful because they enable the identification of anomalies that traditional methods would miss due to their lack of access to detailed process-level data. For example, traditional inspection engines are often blind to such intricate details of traffic and process behavior.

Additionally, another example detection involves identifying traffic to an unknown destination, and based on the supplementary information from the agent application 110, determining that the process name is that of a system or trusted process and recognizing a code injection event and/or anomalous behavior, which can be identified through the parent-child process relationship. Upon detecting such an anomaly, the system can take actions such as blocking the request or generating an alert. This sophisticated detection mechanism would not be possible with traditional systems, as they lack access to such detailed information.

Furthermore, the present systems can detect abnormal and potentially malicious activity by following a series of steps informed by the additional information provided by the agent application. For instance, if the system identifies traffic directed to an unknown destination and finds that the process name belongs to a system process, trusted process, known third-party process, or web browser application, and also detects injected code along with process/resource utilization above a predefined threshold, it can create an alert or take appropriate action. It is worth noting that in various embodiments, resource utilization is not a mandatory criterion for determining potential malicious activity, thus providing flexibility and robustness in threat detection.

By integrating these advanced capabilities, the present systems significantly enhance the overall security posture, enabling more effective detection and mitigation of threats that would otherwise go unnoticed with traditional inspection engines.

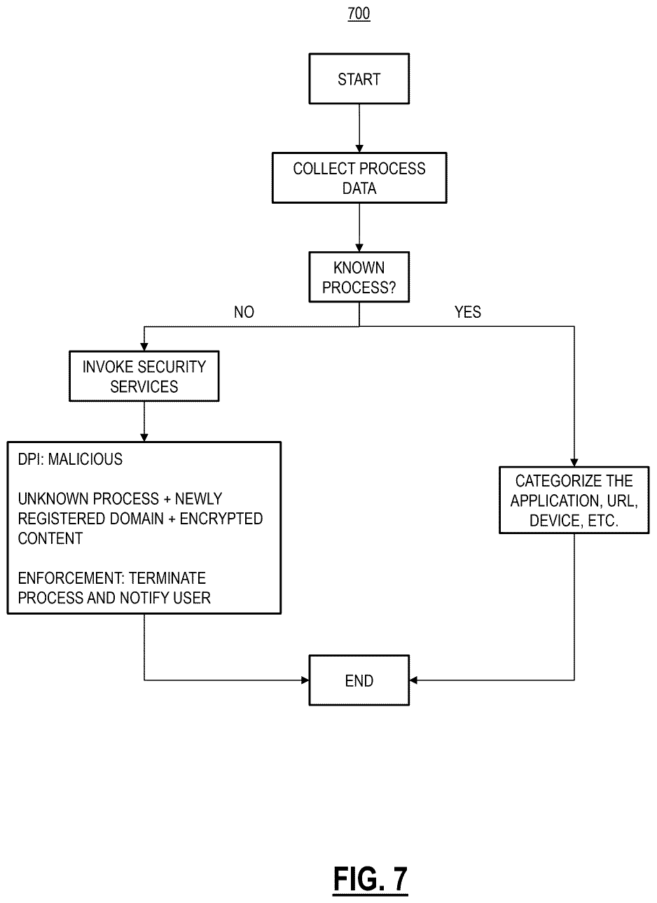

FIG. 7 is a flowchart of an example operation 700 of the present system for utilizing unified inspection data. The following use cases illustrate how the present systems can leverage unified data, enriched by sophisticated smart agents, to provide enhanced security across multiple environments. In this approach, the system first identifies the nature of the process generating the network traffic. By examining the process data supplied by the agent application, the system determines whether this process is already recognized. If it is unfamiliar or unknown, the system engages one or more security services—such as cloud browser isolation, policy enforcement, or deep packet inspection engines—to evaluate the traffic in greater detail. Based on the outcome of these evaluations, the system can then take a variety of actions, such as blocking or isolating the process, alerting an administrator, or further analyzing its behavior.

On the other hand, if the process is recognized and also found to be uncontaminated, the system harnesses the additional data gathered by the agent application to categorize the application, URL, and associated device more precisely. By unifying information about the process with high-level context from the network and endpoints, the system can make informed decisions about traffic handling, automate policy enforcement, and integrate seamlessly with other security solutions. This holistic approach ensures that both known and unknown processes are appropriately evaluated, providing an adaptable and comprehensive security framework for modern networks.

Process-level data can be used for application and URL categorization by bridging detailed information about which executable is generating the network traffic with the destination addresses it attempts to reach. First, the system identifies the executable responsible for the traffic by examining its file path, digital signature, and creation or modification timestamps. If these attributes match known software profiles in a trusted application repository or carry valid digital certificates, the application can be categorized, for example, as a web browser, file-sharing client, or corporate productivity tool. This categorization is further refined by verifying the integrity and authenticity of the process, distinguishing legitimate software from malicious imitators.

Once the application is identified, the security infrastructure correlates it with the specific URLs or domains being accessed. By attributing each connection to the originating process, administrators gain a granular view of both the application's purpose and the types of online resources it engages. Established URL classification engines, mapping sites into categories such as “social media,” “news,” “gaming,” or “malicious”, can now be combined with executable-level context (e.g., a newly installed, unsigned binary connecting to multiple high-risk domains). If the system detects that a trusted application name is initiating calls to suspicious or unknown addresses, it can flag these behaviors for further scrutiny or block them outright.

In addition to these reactive safeguards, the solution also employs behavioral analysis to uncover deviations from normal usage patterns. Repeated connections to a set of consistent and legitimate URLs typically reinforce an application's benign classification. However, anomalies such as sudden spikes in CPU usage, uncharacteristic changes in parent-child process relationships, or recent file creation can point to injection attempts or hidden malware functions and warrant further inspection. By uniting host-level process insights with domain intelligence, the system can detect subtle threats that would otherwise slip past traditional inspection engines focused solely on network packets or minimal endpoint data.

Finally, a feedback loop continuously refines these categorizations. As the system gathers more information on newly observed processes and domains, it updates internal repositories and machine learning models, ensuring that its threat intelligence remains current. This feedback mechanism allows for prompt reclassification if an application once deemed trustworthy begins to exhibit suspicious behaviors or if fresh threat intelligence identifies a domain as malicious. Ultimately, merging process-level data with URL classification creates a more adaptive, robust security framework, enabling both granular policy enforcement and swift responses to emerging threats.

Overall, process-level data enables more precise and proactive detection of malicious activity by illuminating the context behind each network connection or system event. Rather than viewing network traffic in isolation, security solutions can correlate the originating process's name, file path, creation time, digital signatures, and parent-child relationships to determine whether the process is legitimate or potentially harmful. For example, if a trusted system executable suddenly appears in a suspicious directory, or if its file creation timestamp is alarmingly recent, the system flags that process for deeper inspection. Additionally, parent-child process analysis can reveal code injection or hidden scripts that would otherwise be mistaken for benign applications. Armed with these insights, security controls can detect unusual patterns, such as high CPU usage or abrupt changes in process behavior, and intervene before malicious code has the chance to fully execute. By weaving together host-level telemetry with traditional packet inspection, security architectures gain a fuller, real-time picture of potential threats, allowing them to block/terminate processes or quarantine files and traffic far more effectively than would be possible through network inspection alone.

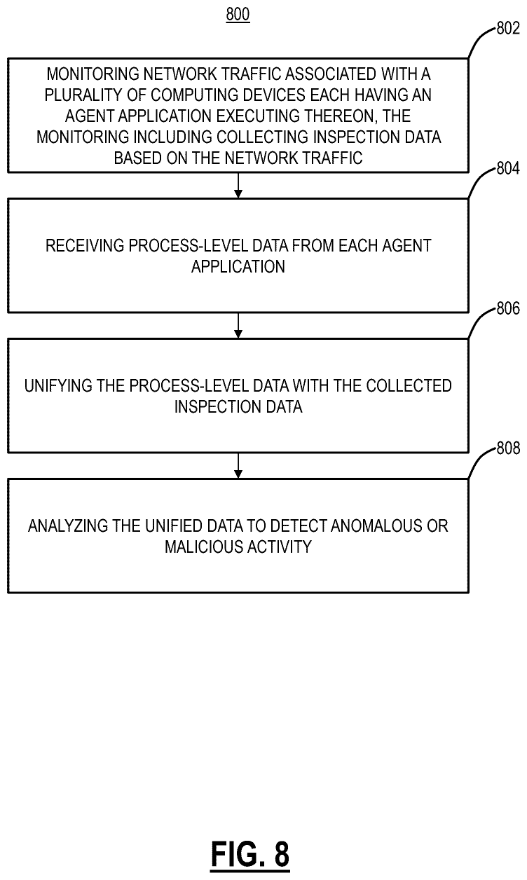

FIG. 8 is a flowchart of a process 800 for improving traffic inspection and response with smart agents and unified inspection data points. In various embodiments, the process 800 can be contemplated as a method having steps, a processing device configured to implement the steps, a cloud-based system configured to implement the steps, and as a non-transitory computer-readable medium storing instructions for programming one or more processors to execute the steps. The process 800 includes monitoring network traffic associated with a plurality of computing devices each having an agent application executing thereon, the monitoring including collecting inspection data based on the network traffic (step 802); receiving process-level data from each agent application (step 804); unifying the process-level data with the collected inspection data (step 806); and analyzing the unified data to detect anomalous or malicious activity (step 808).

The process 800 can further include generating a response action based on the analyzing, wherein the response action includes at least one of blocking suspicious traffic or issuing an alert. The process-level data can include any of a process responsible for the traffic, a file path of a process responsible for the traffic, parent-child process relationships, Central Processing Unit (CPU) usage of a process, an associated company name of a process, and a recent file creation timestamp. The analyzing can include employing one or more cloud-based security services, wherein the one or more cloud-based security services include any of a deep packet inspection engine, a cloud browser isolation service, a policy enforcement engine, and a behavioral analysis module. The steps can further include determine whether a process associated with the network traffic is recognized; responsive to the process being unrecognized, invoking a selected security service for detailed traffic analysis; and applying one or more security policies based on an output of the detailed traffic analysis. The steps can further include determining, based on unified data, a process responsible for traffic executing from a nonstandard directory on a computing device; and performing one or more actions based on the determining, the one or more actions including any of blocking the traffic and alerting an administrator. The steps can further include determining that traffic is directed to an unknown destination; determining that a process responsible for the traffic is any of a core system process, a trusted process, or a known third party process; determining that a file associated with the traffic has a creation timestamp within a predefined threshold; and performing one or more actions based on the determining, the one or more actions including any of blocking the traffic and alerting an administrator. The analyzing can include detecting a code injection or anomalous behavior based on a parent-child process relationship or recent file creation, and generating a security alert upon detecting the code injection. The steps can include utilizing the process-level data to perform application categorization.

### § 6.0 Processing Circuitry and Non-transitory Computer-readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method comprising steps of:
monitoring network traffic associated with a plurality of computing devices each having an agent application executing thereon, the monitoring including collecting inspection data based on the network traffic;
receiving process-level data from each agent application;
unifying the process-level data with the collected inspection data; and
analyzing the unified data to detect anomalous or malicious activity.

2. The method of claim 1, wherein the steps further include generating a response action based on the analyzing, wherein the response action includes at least one of blocking suspicious traffic or issuing an alert.

3. The method of claim 1, wherein the process-level data includes any of a process responsible for the traffic, a file path of a process responsible for the traffic, parent-child process relationships, resource utilization, an associated company name of a process, and a recent file creation timestamp.

4. The method of claim 1, wherein the analyzing includes employing one or more cloud-based security services.

5. The method of claim 4, wherein the one or more cloud-based security services include any of a deep packet inspection engine, a cloud browser isolation service, a policy enforcement engine, and a behavioral analysis module.

6. The method of claim 1, wherein the analyzing further includes:
determine whether a process associated with the network traffic is recognized;
responsive to the process being unrecognized, invoking a selected security service for detailed traffic analysis; and
applying one or more security policies based on an output of the detailed traffic analysis.

7. The method of claim 1, wherein the analyzing includes:
determining, based on unified data, a process responsible for traffic executing from a nonstandard directory on a computing device; and
performing one or more actions based on the determining, the one or more actions including any of blocking the traffic and alerting an administrator.

8. The method of claim 1, wherein the analyzing includes:
determining that traffic is directed to an unknown destination;
determining that a process responsible for the traffic is any of a core system process, a trusted process, or a known third party process;
determining that a file associated with the traffic has a creation timestamp within a predefined threshold; and
performing one or more actions based on the determining, the one or more actions including any of blocking the traffic and alerting an administrator.

9. The method of claim 1, wherein the analyzing includes detecting code injection or anomalous behavior based on a parent-child process relationship or recent file creation, and generating a security alert upon detecting the code injection or anomalous behavior.

10. The method of claim 1, wherein the steps include utilizing the process-level data to perform application categorization.

11. A non-transitory computer-readable medium comprising instructions that, when executed, cause one or more processors to perform steps of:
monitoring network traffic associated with a plurality of computing devices each having an agent application executing thereon, the monitoring including collecting inspection data based on the network traffic;
receiving process-level data from each agent application;
unifying the process-level data with the collected inspection data; and
analyzing the unified data to detect anomalous or malicious activity.

12. The non-transitory computer-readable medium of claim 11, wherein the steps further include generating a response action based on the analyzing, wherein the response action includes at least one of blocking suspicious traffic or issuing an alert.

13. The non-transitory computer-readable medium of claim 11, wherein the process-level data includes any of a process responsible for the traffic, a file path of a process responsible for the traffic, parent-child process relationships, resource utilization, an associated company name of a process, and a recent file creation timestamp.

14. The non-transitory computer-readable medium of claim 11, wherein the analyzing includes employing one or more cloud-based security services.

15. The non-transitory computer-readable medium of claim 14, wherein the one or more cloud-based security services include any of a deep packet inspection engine, a cloud browser isolation service, a policy enforcement engine, and a behavioral analysis module.

16. The non-transitory computer-readable medium of claim 11, wherein the analyzing further includes:
determine whether a process associated with the network traffic is recognized;
responsive to the process being unrecognized, invoking a selected security service for detailed traffic analysis; and
applying one or more security policies based on an output of the detailed traffic analysis.

17. The non-transitory computer-readable medium of claim 11, wherein the analyzing includes:
determining, based on unified data, a process responsible for traffic executing from a nonstandard directory on a computing device; and
performing one or more actions based on the determining, the one or more actions including any of blocking the traffic and alerting an administrator.

18. The non-transitory computer-readable medium of claim 11, wherein the analyzing includes:
determining that traffic is directed to an unknown destination;
determining that a process responsible for the traffic is any of a core system process, a trusted process, or a known third party process;
determining that a file associated with the traffic has a creation timestamp within a predefined threshold; and
performing one or more actions based on the determining, the one or more actions including any of blocking the traffic and alerting an administrator.

19. The non-transitory computer-readable medium of claim 11, wherein the analyzing includes detecting code injection or anomalous behavior based on a parent-child process relationship or recent file creation, and generating a security alert upon detecting the code injection or anomalous behavior.

20. The non-transitory computer-readable medium of claim 11, wherein the steps include utilizing the process-level data to perform application categorization.
